(19) United States
(12) Patent Application Publication
(10) Pub. No.: US 2013/0328438 A1
(43) Pub. Date: Dec. 12, 2013

(54) STATOR OF MOTOR AND METHOD FOR MANUFACTURING THE STATOR

(71) Applicants: Jeong Cheol Jang, Gwangju (KR); Ji Min Lee, Gwangju (KR)

(72) Inventors: Jeong Cheol Jang, Gwangju (KR); Ji Min Lee, Gwangju (KR)

(73) Assignee: NEW MOTECH CO., LTD., Gwangju (KR)

(21) Appl. No.: 14/001,496

(22) PCT Filed: Jan. 31, 2012
(86) PCT No.: PCT/KR2012/000707

§ 371 Date: Aug. 23, 2013

(30) Foreign Application Priority Data
Apr. 13, 2011 (KR) 10-2011-0034146

(51) Int. Cl. H02K 1/18; H02K 15/02

(52) U.S. Cl. CPC H02K 1/187; H02K 15/024
USPC 310/216.113; 29/596

(57) ABSTRACT

Disclosed is a stator of a motor having a stator core having a plurality of teeth protruded therefrom and a slot formed between the adjacent teeth; and at least one or more L-shaped coupling members adapted to be attached to given positions on a side peripheral surface of the stator core, each L-shaped coupling member having a flat surface portion and a side wall portion, the flat surface portion 2a having a fastening hole formed thereon.

### TECHNICAL FIELD

The present invention relates to a stator of a motor, and more particularly, to a stator of a motor and a method for manufacturing the stator that does not have any separate insulators for insulating a stator core and is configured in a simple way, thereby reducing the manufacturing cost and simplifying the manufacturing process.

### BACKGROUND ART

In general, a motor consists of a stator and a rotor rotatably disposed on the outer or inner periphery of the stator. The stator of the motor has a stator core having a plurality of teeth formed in an outer or inner peripheral direction thereof, and the surface of the stator core is insulated by means of insulators. Next, the coils are wound around the teeth.

The stator cores in the conventional practices are disclosed in Korean Patent Application Laid-Open Nos. 10-2007-0111808 and 10-2005-0069048. According to the conventional practices, the insulator, which is made of an insulating resin, is coupled to the upper and lower portions of the stator core, and the coils are wound around the teeth, thereby manufacturing the stator. Further, the insulator has coupling bushings adapted to be coupled to a motor set. Accordingly, a separate mold is needed for manufacturing the insulators, and furthermore, if the insulators are coupled to the stator core, the slot formed between the adjacent teeth becomes narrow by the thickness of each insulator itself, which causes the number of coils wound around the teeth to be restricted, thereby failing to satisfy a user's demand for the electromagnetic properties needed for the stator. Besides, the formation of the coupling bushings causes the insulating resin used to be increased in amount, thereby raising the manufacturing cost thereof.

So as to solve the above-mentioned conventional problems, thus, this inventors propose to a stator of a motor having a new structure in which insulators made of an insulating resin are not needed.

### DISCLOSURE OF INVENTION

### Technical Problem

Accordingly, the present invention has been made in view of the above-mentioned problems occurring in the prior art, and it is an object of the present invention to provide a stator of a motor that has a new structure with no need for insulators made of an insulating resin.

It is another object of the present invention to provide a stator of a motor that is capable of reducing the production cost thereof.

It is still another object of the present invention to provide a stator of a motor that is capable of simplifying the manufacturing process thereof.

The above object and other objects of the present invention will be easily achieved by a preferred embodiment of the present invention as will be described below.

### Solution to Problem

To accomplish the above objects, according to an aspect of the present invention, there is provided a stator of a motor including: a stator core having a plurality of teeth protruded therefrom and a slot formed between the adjacent teeth; and at least one or more L-shaped coupling members adapted to be attached to given positions on a side peripheral surface of the stator core, each L-shaped coupling member having a flat surface portion and a side wall portion, the flat surface portion having a fastening hole formed thereon.

According to the present invention, desirably, the stator core to which the at least one or more L-shaped coupling members are attached is coated with insulating powder on the entire surface thereof.

According to the present invention, desirably, the flat surface portion of each L-shaped coupling member further has an arrangement hole formed thereon.

According to the present invention, desirably, the stator of a motor further includes an insulating bushing adapted to be inserted into the fastening hole and having a body, a flange formed on the top portion of the body and having an outer diameter larger than the body, and a hollow portion formed passed through the body and the flange.

To accomplish the above objects, according to another aspect of the present invention, there is provided a method for manufacturing a stator including the steps of: preparing a stator core having a plurality of teeth protruded therefrom and a slot formed between the adjacent teeth; attaching at least one or more L-shaped coupling members to given positions on a side peripheral surface of the stator core; coating the entire outer surface of the stator core to which the at least one or more L-shaped coupling members are attached with insulating powder; and coupling an insulating bushing to the fastening hole of each L-shaped coupling member.

### Advantageous Effects of Invention

According to the present invention, there is provided the stator of a motor having a new structure with no need for insulators made of an insulating resin, while reducing the production cost thereof and simplifying the manufacturing process thereof.

### BRIEF DESCRIPTION OF DRAWINGS

FIG. 1 is a plane view showing a stator of a motor according to the present invention.

FIG. 2 is a perspective view showing one of L-shaped coupling members in the stator of a motor according to the present invention.

FIG. 3 is a perspective view showing an insulating bushing coupled to the L-shaped coupling member in the stator of a motor according to the present invention.

FIG. 4 is a sectional view of the insulating bushing taken along the line A-A′ in FIG. 3.

FIG. 5 is a flowchart showing a method for manufacturing a stator according to the present invention.

### BEST MODE FOR CARRYING OUT THE INVENTION

Hereinafter, an explanation on a stator of a motor according to the present invention will be in detail given with reference to the attached drawings.

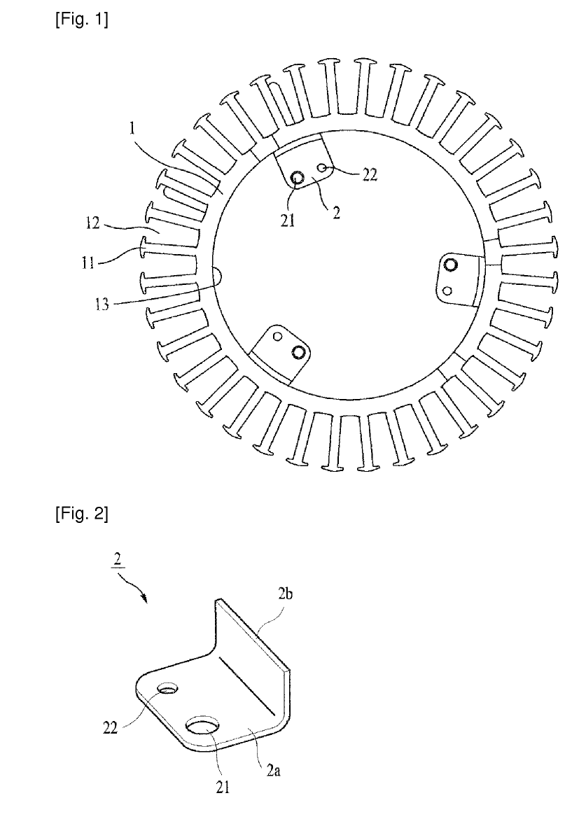

FIG. 1 is a plane view showing a stator of a motor according to the present invention.

As shown in FIG. 1, the stator of a motor according to the present invention includes a stator core 1 having a plurality of teeth 11 protruded therefrom and a slot 12 formed between the adjacent teeth 11 and at least one or more L-shaped coupling members 2 adapted to be attached to given positions on a side peripheral surface 13 of the stator core 1. Further, insulating powder is coated on the outer surfaces of the stator core 1 and the L-shaped coupling members 2.

The stator core 1 is made by stacking thin steel plates on top of each other, and alternatively, it is made by connecting a given number of divided cores to each other. In addition thereto, the stator core 1 may be made in a variety of ways. That is, if the stator core 1 used in the stator of a motor according to the present invention has the plurality of teeth 11 and the slots 12 irrespective of its manufacturing method, the shape of the stator core 1 does not matter. Moreover, the teeth 11 are formed radially from the outer peripheral side of a circle in FIG. 1, and of course, they can be formed radially toward the center of the circle. If a rotor for a motor is located outside the stator, the teeth 11 are protruded toward the outer peripheral direction of the circle, and contrarily, if the rotor is located inside the stator, they are protruded toward the inner peripheral direction of the circle. In case of the former, the side peripheral surface 13 becomes the inner peripheral surface of the circle as shown in FIG. 1, and in case of the latter, it becomes the outer peripheral surface of the circle.

The at least one or more L-shaped coupling members 2 are coupled to the side peripheral surface 13 of the stator core 1. The L-shaped coupling members 2 serves to couple the stator core 1 to a motor set. A configuration of each L-shaped coupling member 2 will be explained with reference to FIG. 2.

FIG. 2 is a perspective view showing one of L-shaped coupling members in the stator of a motor according to the present invention.

As shown in FIG. 2, each L-shaped coupling member 2 has a flat surface portion 2a and a side wall portion 2b in such a manner as to take a shape of ‘L’ having an approximately 90.

The flat surface portion 2a has a fastening hole 21 and an arrangement hole 22 formed thereon.

The fastening hole 21 is a hole into which fastening means like a bolt is inserted to couple the stator to the motor set. As a result, the stator can be fixed to the motor set by means of the fastening means like the bolt. The arrangement hole 22 is formed correspondingly to an arrangement protrusion formed on the motor set so as to adjust the positions to be fixed to the stator. As a result, the position of the arrangement hole 22 corresponds to the arrangement protrusion of the motor set, and next, the fastening means is inserted into the fastening hole, thereby finishing the fixing of the stator to the motor set.

The side wall portion 2b of each L-shaped coupling member 2 is attached on the outer surface thereof to the side peripheral surface 13 of the stator core 1. The attaching method is not specially limited, but desirably, the side wall portion 2b can be attached to the side peripheral surface 13 by means of welding. In addition thereto, separate fastening means or various attaching methods may be provided. The number of L-shaped coupling members 2 is determined upon the demand for coupling of the motor set. In FIG. 1, three L-shaped coupling members 2 are attached to the side peripheral surface 13 of the stator core 13.

Like this, in the state where the at least one or more L-shaped coupling members 2 are attached to the side peripheral surface 13 of the stator core 13, the coating of the insulating powder is performed on the entire surfaces of the stator core 1 and the L-shaped coupling members 2. Commercial epoxy powder is used as the insulating powder, but of course, it is not limited thereto. A variety of insulating materials can be used as the insulating powder, if they are applicable. That is, the insulating materials in a liquid state or in other shapes as well as the insulating powder can be applied thereto. A variety of coating methods such as electrodeposition, spraying and so on may be adopted. Like this, according to the present invention, since the insulation for the stator is performed by the application of the insulating powder, the spaces in the slots 12 are larger than those when insulators made of an insulating resin are coupled individually, thereby increasing the number of coils wound around the teeth. Further, the insulating coating is performed at a lower cost than the cost of manufacturing the insulators, thereby reducing the manufacturing cost. Moreover, the insulating coating is just performed, without having any process for coupling the insulators, thereby simplifying the manufacturing process.

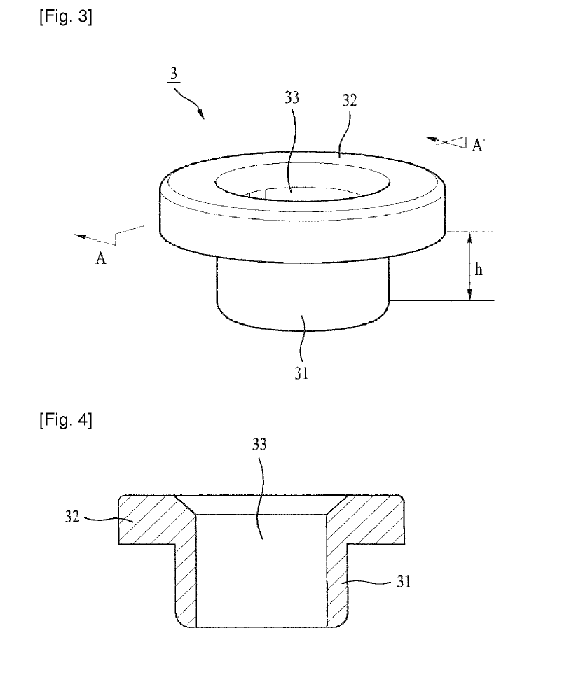

As mentioned above, before the stator made through the coating with the insulating powder is fastened directly to the motor set, the interior of the fastening hole 21 of each L-shaped coupling member 2 should be insulated. In case where the bolt is fastened to the fastening hole 21, the coated surface with the insulating powder may be removed to cause electric current to be applied thereto. Accordingly, an insulating bushing 3 made of an insulating resin is fittedly coupled to the fastening hole 21. A structure of the insulating bushing 3 will be explained with reference to FIGS. 3 and 4.

FIG. 3 is a perspective view showing an insulating bushing coupled to the L-shaped coupling member in the stator of a motor according to the present invention, and FIG. 4 is a sectional view of the insulating bushing taken along the line A-A′ in FIG. 3.

As shown in FIG. 3, the insulating bushing 3 has a body 31, a flange 32, and a hollow portion 33 formed passed through the body 31 and the flange 32. Desirably, the body 31 and the flange 32 are made of the insulating resin to have a unitary body to each other.

As shown in FIG. 3, the body 31 is disposed to have a height h on the underside of the flange 32. Since the flange 32 has the body 31 and the hollow portion 33 formed thereon, the flange 32 has the same inner diameter as them, but has an outer diameter larger than the body 31. The height h of the body 31 desirably has the same depth as the fastening hole 21.

As a result, the insertion of the insulating bushing 3 into the fastening hole 21 prevents electric current from being applied to each L-shaped coupling member 2 and the motor set through the bolts used for coupling the stator and the motor set.

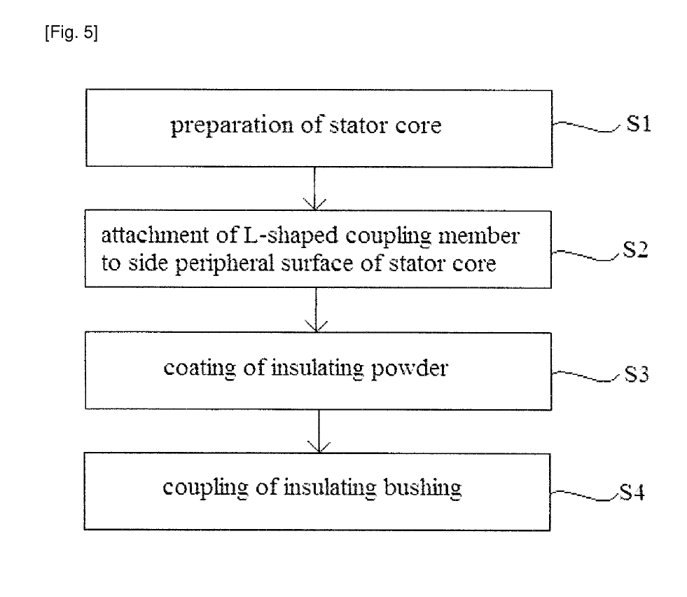

FIG. 5 is a flowchart showing a method for manufacturing a stator according to the present invention.

At a step S1, first, the stator core 1 having the plurality of teeth 11 protruded therefrom and the slots 12 formed between the adjacent teeth is prepared. Next, the at least one or more L-shaped coupling members 2 are attached to given positions on the side peripheral surface 13 of the stator core 1, at a step S2. After that, the insulating powder is coated on the entire outer surface of the stator core 1 to which the at least one or more L-shaped coupling members 2 are attached, at a step S3. Lastly, the insulating bushing 3 is coupled to the fastening hole 21 of each L-shaped coupling member 2, at a step S4.

In the stator made through the above-mentioned processes the fastening means like a bolt is fastened to the fastening hole 21 so as to couple the stator to the motor set, thereby finishing manufacturing the motor.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A stator of a motor, comprising:
a stator core 1 having a plurality of teeth 11 protruded therefrom and a slot 12 formed between the adjacent teeth 11; and
at least one or more L-shaped coupling members 2 adapted to be attached to given positions on a side peripheral surface 13 of the stator core 1, each L-shaped coupling member 2 having a flat surface portion 2a and a side wall portion 2b, the flat surface portion 2a having a fastening hole 21 formed thereon.

2. The stator of a motor according to claim 1, wherein the stator core 1 to which the at least one or more L-shaped coupling members 2 are attached is coated with insulating powder on the entire surface thereof.

3. The stator of a motor according to claim 1, wherein the flat surface portion 2a of each L-shaped coupling member 2 further has an arrangement hole 22 formed thereon.

4. The stator of a motor according to claim 1, further comprising an insulating bushing 3 adapted to be inserted into the fastening hole 21 and having a body 31, a flange 32 formed on the top portion of the body 31 and having an outer diameter larger than the body 31, and a hollow portion 33 formed passed through the body 31 and the flange 32.

5. A method for manufacturing a stator comprising the steps of:
preparing a stator core 1 having a plurality of teeth 11 protruded therefrom and a slot 12 formed between the adjacent teeth 11;
attaching at least one or more L-shaped coupling members 2 to given positions on a side peripheral surface 13 of the stator core 1;
coating the entire outer surface of the stator core 1 to which the at least one or more L-shaped coupling members 2 are attached with insulating powder; and
coupling an insulating bushing 3 to a fastening hole 21 of each L-shaped coupling member 2.
